(19) United States
(12) Patent Application Publication
(10) Pub. No.: US 2024/0013436 A1
(43) Pub. Date: Jan. 11, 2024

(54) UNCONSTRAINED CALIBRATION SYSTEM AND METHOD FOR SENSOR SUITES IN ROBOTICS

(71) Applicant: MOV. AI Ltd., London (GB)

(72) Inventors: Lúcia Marília Matos CARREIRA, Rio de Mouro (PT); Jorge Miguel dos Santos Pais RIBEIRO, Loures (PT); Joseph APPELBAUM-ELAD, Jerusalem (IL); Kfir BLAIER, Ra'anana (IL)

(73) Assignee: MOV. AI Ltd., London (GB)

(21) Appl. No.: 18/195,408

(22) Filed: May 10, 2023

Related U.S. Application Data
(60) Provisional application No. 63/359,850, filed on Jul. 10, 2022.

(51) Int. Cl. G06T 7/80; G01S 7/497; G01S 7/52

(52) U.S. Cl. CPC G06T 7/80; G01S 7/497; G01S 7/52004

(57) ABSTRACT

Systems and methods for calibrating a plurality of sensors attached to a mobile robot include: obtaining, a first set of measurement scans of a calibration target; determining, for each sensor, based on the first set of measurement scans, a pose of the calibration target with respect to each sensor; computing, for each sensor, a first transform from a reference frame of the pose of the calibration target to a reference frame of each sensor; and computing, based on the first transform, a second transform from a reference frame of at least one sensor to a reference frame of a fixed reference point.

### CROSS-REFERENCE TO RELATED APPLICATIONS

This application claims the benefit of U.S. Provisional Patent Application Ser. No. 63/359,850, filed Jul. 10, 2022, which is hereby incorporated by reference in its entirety.

### FIELD OF THE INVENTION

The present invention relates generally to calibration of sensors assembled on a robot, in particular to estimation of the pose (e.g. six degrees of freedom in position and orientation) of sensors relative to a reference point, such as a reference point in the robot, as well as estimation of the poses between pairs of sensors.

### BACKGROUND OF THE INVENTION

It is expected that in the near future automation will take over even more mechanical tasks which are ordinarily performed by people. Therefore, the area of robotics is expected to expand at a fast rate in the coming years. Accordingly, there is a need to optimize the interaction of robots with the environment, as robots may be more frequently inserted in increasingly chaotic scenarios alongside people and may be required to interact with both people and objects.

The various algorithms typically seen in robotics for self-localization, trajectory calculation, obstacle bypassing, and motion control all assume that the sensors mounted on the robot structure are at known poses (a term referring to the six degrees of freedom in position and/or orientation, namely X, Y, Z/height and yaw, roll, and pitch). These sensors provide measurements relative to the robot's pose and knowing the poses of the sensors helps to infer the poses of objects surrounding the robot. Any deviation from the assumed sensor poses can impact the precision and effectiveness of these algorithms. Sensor poses are typically assumed based on the mechanical design (e.g. computer aided design “CAD” model) of the robot. During the assembly of a robot, the sensors may be mounted with slight deviations in relation to the original CAD model. These deviations must typically be calculated individually for every robot. The deviation measurements may then be used in various localization and navigation algorithms to enable a correct outcome. It is possible to manually (performed by a human) align the sensors by comparing the sensed data with external ground truth, typically a distinctive feature in the environment, but this is a grueling and time consuming task.

An automatic method of calibration would therefore be valuable in order to provide accurate, automated, and fast calibration of robots.

### SUMMARY

According to one or more embodiments, there is provided a method of calibrating a plurality of sensors attached to a mobile robot, the method including: obtaining, by each sensor of the plurality of sensors, a first measurement scan of a calibration target; determining, for each sensor of the plurality of sensors, based on the first measurement scan, a pose of the calibration target with respect to each sensor; computing, for each sensor of the plurality of sensors, a first transform from a reference frame of the pose of the calibration target to a reference frame of each sensor; and computing, based on the first transform, a second transform from a reference frame of at least one sensor of the plurality of sensors to a reference frame of a fixed reference point.

Embodiments may allow for fast and consistent calibration of a fleet of robots of the same or different types, such that the sensor measurements and the robot's perception of the world is as close as possible to reality and a movement controller of the robot can accurately navigate the real world environment.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals indicate corresponding, analogous or similar elements, and in which:

FIG. 1 is a schematic illustration of a sensor configuration, according to some embodiments of the invention;

FIG. 2A is an image of a calibration target, according to some embodiments of the invention;

FIG. 2B is a plan view of a calibration target, according to some embodiments of the invention;

FIG. 2C shows several views of a calibration target, according to some embodiments of the invention;

FIG. 2D is a representation of a pattern, according to some embodiments of the invention;

FIG. 3 is a schematic diagram of a robot, according to some embodiments of the invention.

FIG. 4A is a flowchart of a method, according to some embodiments of the invention;

FIG. 4B is a flow diagram for data acquisition, according to some embodiments of the invention;

FIG. 4C is a flowchart of a method, according to some embodiments of the invention;

FIG. 4D is a flow diagram for sensor calibration, according to some embodiments of the invention;

FIG. 4E is a diagram showing a calibration geometry, according to some embodiments of the invention;

FIG. 5A is a flow diagram for sensor calibration, according to some embodiments of the invention;

FIG. 5B is a diagram showing a calibration geometry, according to some embodiments of the invention; and

FIG. 6 is a flow diagram for sensor calibration, according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Calibration methods in accordance with embodiments of the invention include estimating each sensor's pose relative to a reference point, such as a reference point in the robot, so that small misalignments from mechanical design (or caused by degradation over time or other factors) are accounted for during execution of the disclosed algorithms. Good calibration of the sensors may result in optimized behavior of the robot in tasks such as localization in a map and interaction with objects. There is also added value in detecting miscalibration of the sensors while the robot is operating, so that maintenance time can be planned by the operator, instead of stopping operation because the robot cannot function properly.

The present invention may be used with, for example, two-dimensional “2D” and three-dimensional “3D” ranging sensors, red-green-blue “RGB” and red-green-blue-depth “RGBD” cameras, and inertial measurement units “IMUs”, or other sensors. Embodiments of the invention provide a general methodology for calibrating (e.g. determining six degrees of freedom) any type of sensor attached to any type of robot. Embodiments of the invention allow for an integrator to define sensor layouts/configurations for a particular robot once and then allow for automatic calibration of all similar robots. Small adjustments to the configurations may be required on each new similar robot, for instance, configuring an extra sensor. Embodiments may allow for simultaneous calibration of sensors using the motion of the robot, regardless of the number of sensors, structure of the robot/assembly of the sensors in the robot, number of stages of data collection, or existing calibration of a mobile robot. Embodiments of the present invention may calibrate a robot's sensors automatically, without manual intervention, human supervision, or further input from a user during the process. The result of the calibration may be for example data (e.g. a set of matrices) describing the distortion of the sensors from an original CAD model, e.g. a design of the robot. Up to certain values, e.g. threshold values such as determined by safety standards, the distortion can be acceptable, and the algorithms may function properly. Beyond certain values however, the distortion may be too large and the sensor and/or robot may no longer be compliant with safety standards. An operator of the robot may be alerted that hardware maintenance is required to mechanically reposition the sensor. Calibration of the sensors may be performed for reasons other than compliance with safety standards, for example for ensuring various robot algorithms perform as expected such as localization and navigation.

The calibration process according to embodiments of the present invention may be fast enough for it to be performed more regularly than prior art methods and may alert the operator of distortions that happen over time and of gradual degradation. Embodiments of the present invention allow for preventative maintenance to occur by decision of the operator, rather than having to perform unscheduled maintenance when the robot inconveniently stops functioning due to excessive misalignments of sensors.

To the inventors' knowledge, existing calibration solutions do not allow for fast and simultaneous calibration of all the sensors of a robot to each other or to a reference to the extent of six degrees of freedom “6DoF” (3 translations XYZ and 3 orientations roll, pitch, and yaw). Existing automated calibration methods for planar movement of autonomous mobile robots “AMRs” do not account for 6DoF.

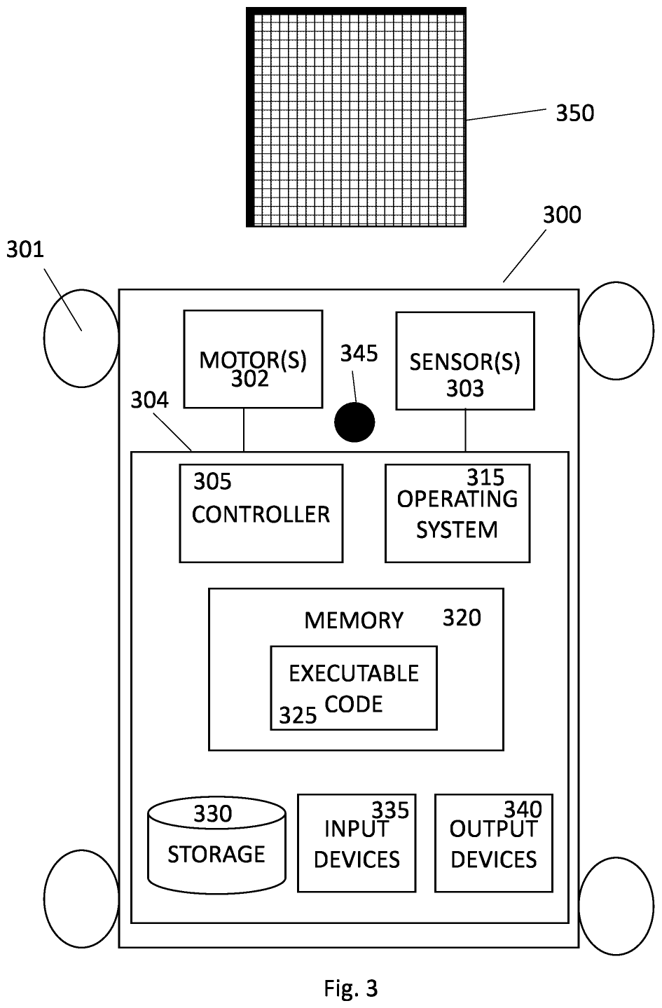

Embodiments of the present invention relate to novel algorithms, hardware, and apparatuses (e.g. a calibration target) for calibrating a suite of sensors assembled on a robot, such as a robot 300 depicted in FIG. 3. All sensors may be calibrated with respect to a reference point, which can be an estimated fixed point (e.g. 345) in the robot.

Some embodiments of the present invention require the robot to be placed or moved to be in front of a calibration target. The robot may perform required movements for data acquisition autonomously without any intervention from a user during the process.

Methods in accordance with embodiments of the invention may make use of the calibration target to obtain: (1) measurements of matching relative poses of pairs of sensors; and (2) absolute references that may be used to determine degrees of freedom of the pose that require a known reference in the environment.

Embodiments of the present invention also relate to a novel design for a calibration target. The target may be designed to be used with depth sensors (RGB and RGBD cameras, 2D and 3D lidars and similar). The design is suitable for use with several types of different sensors. The same algorithm may apply to different models of the same type of sensor.

Furthermore, the present invention includes a software tool that allows the expansion of calibration to new sensor types, as well as the definition of the calibration functions in a modular fashion.

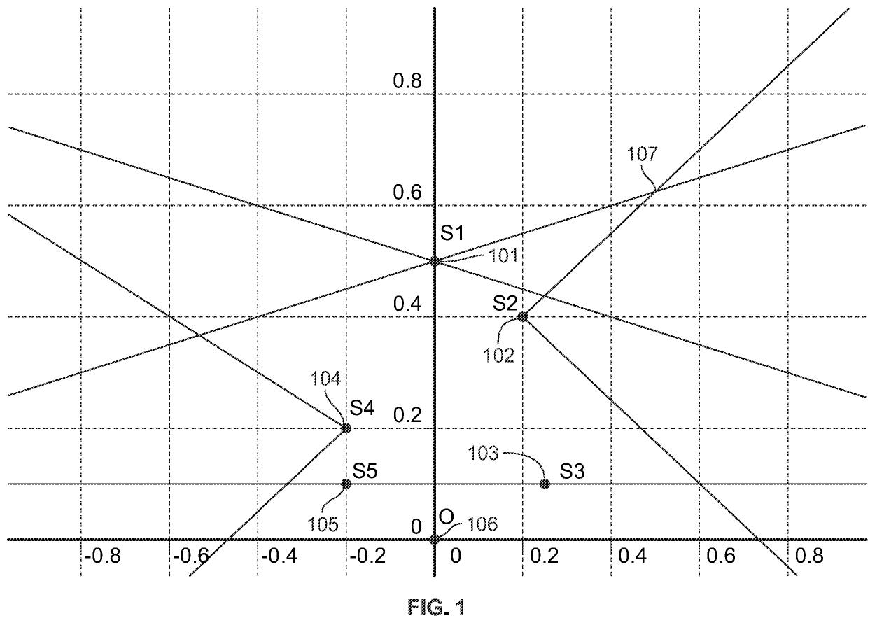

With reference to FIG. 1, an embodiment of the present invention includes the calibration of an omni-directional lidar 101, two RGBD cameras 102, 104 and two two-dimensional (2D) lasers 103, 105 to a reference point 106 in the robot where they are assembled. Calibration matrices for the transforms between pairs of sensors and to a reference frame (origin and axes directions) are estimated based on the overlap between the sensors' field of view 107 and/or pose estimations of the same object viewed by different sensors simultaneously. The sensors of FIG. 1 may be incorporated into a robot such as depicted in FIG. 3.

The reference point to which all the sensors are calibrated may be any of a fixed reference given by the user, a point 106 in the robot (known from CAD model or estimated with the present system), or one of the sensors itself.

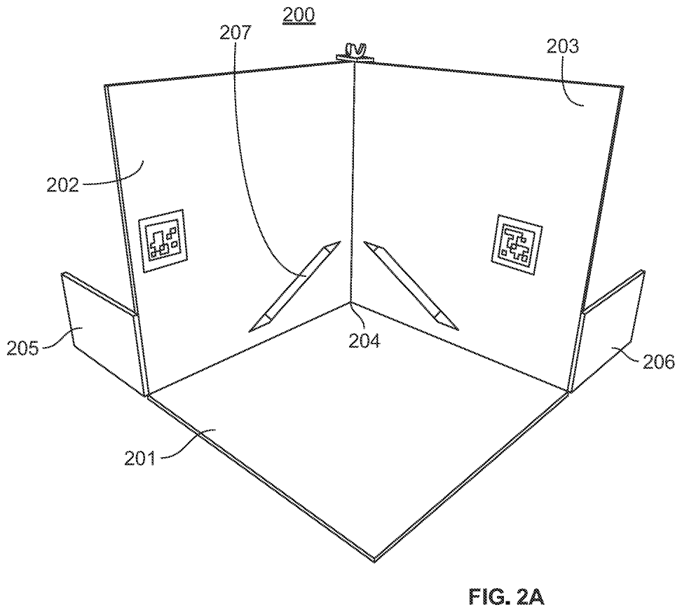

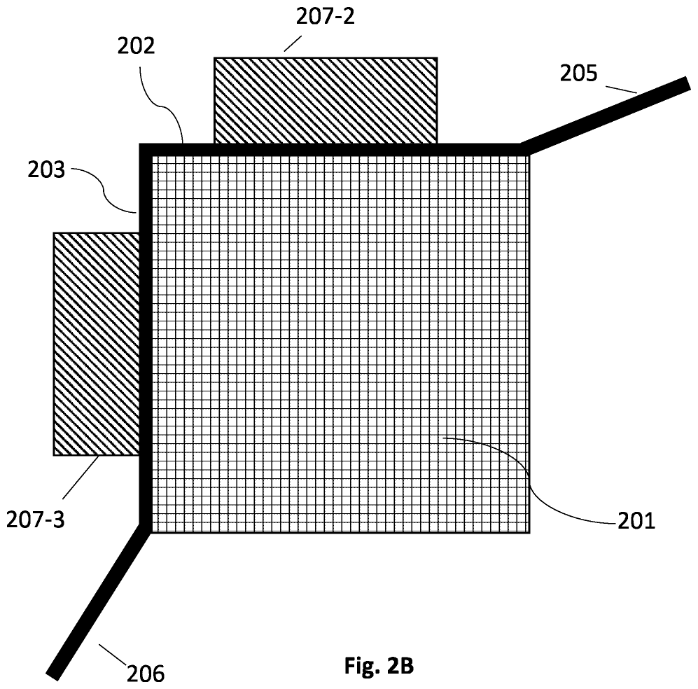

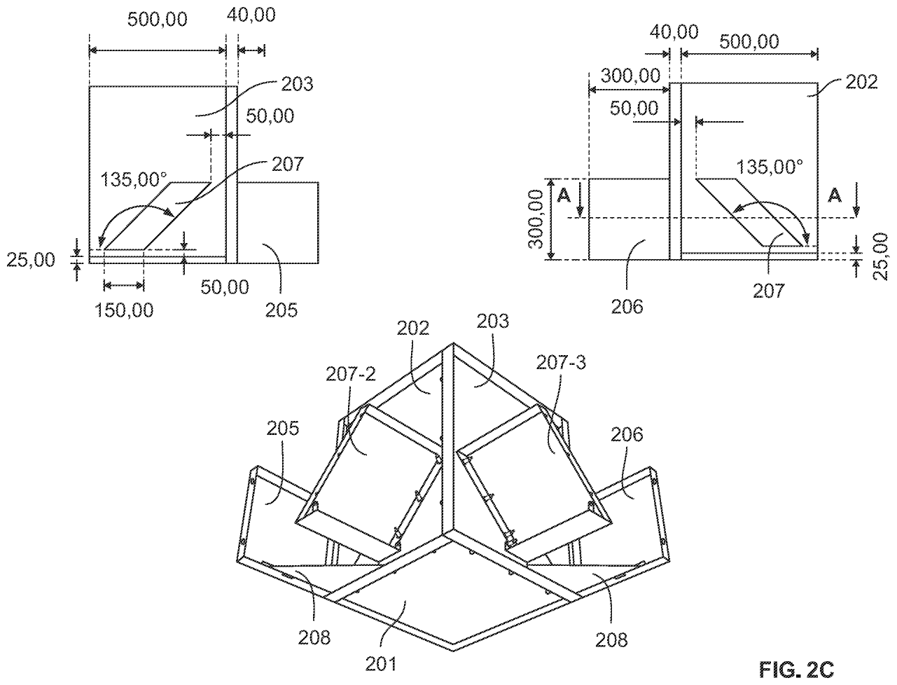

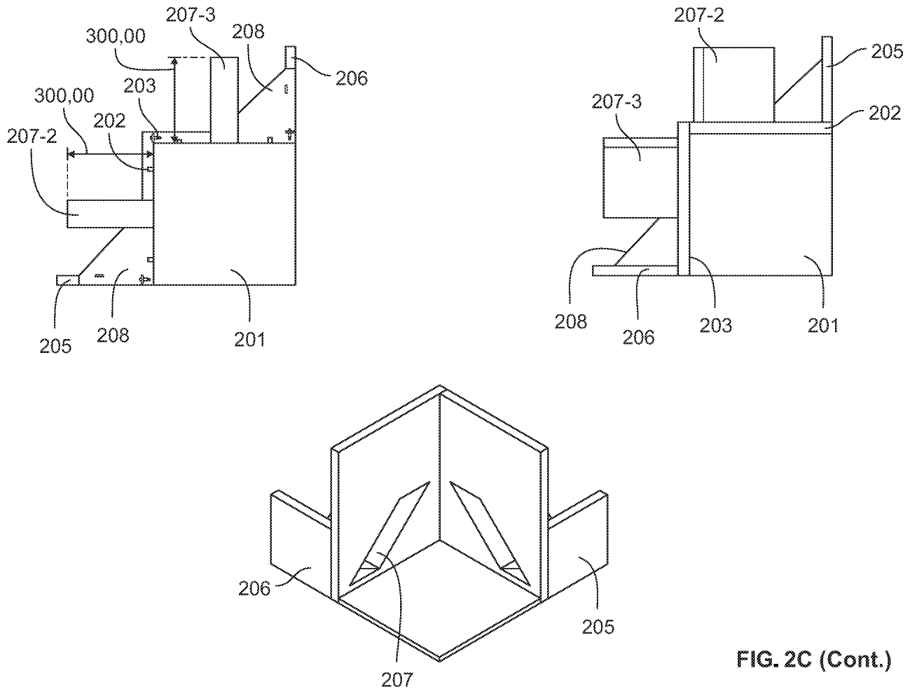

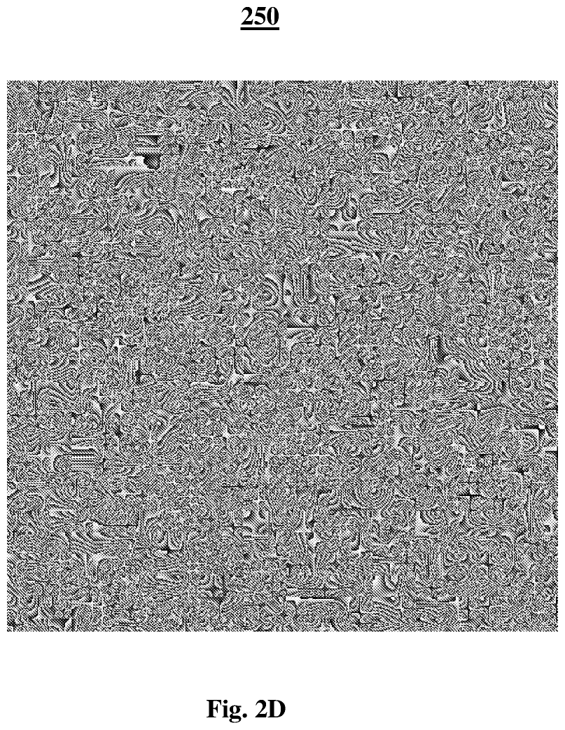

Embodiments of the invention include various methodologies for the calibration of a robot, for example: (1) calibration using a jig, whereby the robot is placed in an exact location and alignment so that all the sensors' poses may be measured accurately; (2) an unconstrained method using a calibration target (e.g. 200 in FIG. 2) with known dimensions and 3D features, that can be deployed anywhere and without precise alignment of the robot; and (3) an unconstrained calibration method that uses features from the environment without requiring any specific hardware. Aspects of different embodiments may be used with other embodiments.

In one embodiment, the omni-direction lidar 101 acts as the main sensor, in the sense that its field of view is 360°, and it will therefore have an overlapping field of view with all of the other sensors. A specific point in space, such as a target, may be detected by all sensors in their reference frames, for example by moving the robot (e.g. by direct control, such as via joystick, or autonomously on its own) so as to capture sensor data of the target from each of the sensors. Since the target may be seen by all sensors, the transform between each sensor's reference frame can be computed.

With reference to FIG. 2A, according to an embodiment of the present invention there is provided a calibration target 200, e.g. a target for calibrating robotic sensors. Calibration target 200 may include three planes 201, 202, and 203. Plane 201 may instead be formed by the physical ground, for example the surface on which the target is placed, or the floor beneath where the target is mounted at height. The planes may be referred to as ground plane 201, first vertical plane 202 and second vertical plane 203. Planes 201, 202, and 203 may be mutually orthogonal, for example forming a corner 204. In embodiments where ground plane 201 is formed by the physical ground, planes 202 and 203 may still be orthogonal to each other, and form a corner with the physical ground. Whilst the target is shown in FIG. 2 as being substantially square, the shape of the target is not fixed, but determined by certain requirements, which include knowing the exact dimensions of the main planes (e.g. planes 201, 202, and 203) of the target and the location of any 3D features on the target. In some embodiments, the target 200 is triangular in form. In such cases, orthogonality may be used in a generalized way as not meaning at right angles but as forming a corner or coming to a point, for example, with triangular planes, the planes may be at 120° with respect to each other, and the target may be placed so as to see “into” the interior of the target where the corner is formed.

Each plane of the target may be colored differently (e.g. in a color other than white) to facilitate identification of the plane points when calibrating an RGBD camera. For example, plane 201 may be colored red, plane 202 may be colored green and plane 203 may be colored blue. According to some embodiments, the planes are shaded, for example in shades of white, black, and/or grey. A shade may include varying brightness or darkness levels of colors that do not rely on or include non-white colors. Shades of white, black and/or grey may be used, for example, to calibrate cameras or optical sensors which do not sense color. Target 200 may be constructed from one or more different materials, such as one or more materials which have different reflectivity properties. The different reflectivity properties may help a sensor of the robot distinguish between the different planes of the target. It should be noted that whilst coloring and/or shading of the target may be helpful for identification, it is not required.

Embodiments of the invention may optimize an estimation of the target size (e.g. as determined by sensor scans/measurements) by the addition of a structure, such as a flap, to the outer sides of the calibration target, which may improve an accuracy of a measurement of the dimensions of the target. For example, the first and second vertical planes may include a structure forming respective third and fourth planes 205 and 206. These additional planes 205 and 206 may not be of the same dimensions as planes 202 and 203. For example, additional vertical planes 205 and 206 may be half-height planes, e.g. only being half the height of planes 202 and 203. Third and fourth vertical planes 205 and 206 may be placed at an angle relative to the vertical plane to which they are attached. For example, third vertical plane 205 may be formed at 90 degrees to first vertical plane 202. In other embodiments, third and fourth vertical planes 205 and 206 are placed at angles which avoid any of planes 202, 203, 205 or 206 from being parallel (see, e.g. FIG. 2B). The edges of the calibration target must be clearly defined for calibrating a 2D laser, for example by using 90° edges rather than rounded corners, however rounded corners on the target are still suitable for calibrating other sensors such as cameras or 3D lidar.

Vertical planes 202 and 203 may each have a distinctive 3D feature, such as a gap, slot, or opening 207, which can be detected by an imaging system of the robot. Gap 207 may be diagonal. For example, gap 207 may be inclined at any angle θ in the ranges 0<θ<90°, 90°<0<180° relative to the plane of the floor, e.g. inclined at 45° relative to the plane of the floor. In alternative embodiments, the distinctive 3D feature is a beam attached to the face of the vertical plane. The beam may be diagonal, for example inclined at any angle θ in the ranges 0<θ<90°, 90°<θ<180° relative to the plane of the floor, e.g. inclined at 120° relative to the plane of the floor.

A calibration target 200 provided as a standard will be understood to have all dimensions between the parts known and recorded, e.g. in a digital file. The preferred height range for this feature in robotics applications is the height range of safety requirements: Safety standards require robots to have certified mechanisms in order to detect obstacles in their direction of motion, for example a safety laser installed at approximately 20 cm above the ground.

With reference to FIG. 2B, which shows a top-down view of calibration target 200, embodiments of the invention may optimize gap(s) 207 for an accurate detection by two dimensional (2D) sensors (e.g. a laser line scanner) by adding a structure, such as a flap to the back of the gap(s). This structure may form a rear plane, for example respective fifth and sixth planes 207-2 and 207-3 attached to the gaps of planes 202 and 203. The fifth and sixth planes 207-2 and 207-3 may be at an angle, for example tilted away from first and second vertical planes 202 and 203 so as not to be parallel or even coplanar with the respective vertical plane to which they are attached. The fifth and sixth vertical planes may be angled behind the gaps so as to be detected and distinguished by the 2D sensor from the vertical plane to which they are attached, because 2D sensors obtain limited information about the environment. In one embodiment the edge of the gap is very clearly defined in all its length, for example by ensuring an accurate manufacturing process which produces straight edges. As seen in FIG. 2B, ground plane 201 may be a constructed plane, or may be formed by the physical surface on or above which planes 202 and 203 are placed.

FIG. 2C shows several views of a calibration target, according to some embodiments of the invention. FIG. 2C includes example dimensions in centimeters and angles in degrees. A European convention of a coma (,) rather than a period/fullstop (.) has been used for the decimal separator (decimal point). In the first sheet of FIG. 2C the views show: (top left) a “face-on” view of the second vertical plane 203 inclusive of gap 207 and additional third plane 205; (top right) a “face-on” view of the first vertical plane 202 inclusive of gap 207 and additional fourth plane 206; and (bottom) an angled view from below showing a possible arrangement of the structures at the back of gap 207, e.g. fifth and sixth planes 207-2 and 207-3, as well as supporting structure(s) 208. Supporting structure(s) 208 may provide support to third and fourth planes 205 and 206. In the second sheet of FIG. 2C (i.e. FIG. 2C (Cont.)) the views show: (top left) a bottom view of the calibration target showing how support structure(s) 208 attach to third and fourth planes 205 and 206; (top right) a top-down plan view similar to FIG. 2B but with a different angle between planes 205 and 202, and planes 206 and 203; and (bottom) a side view similar to FIG. 2A.

Target 200 may be manufactured in various materials. Materials such as metal ensure better accuracy when used with embodiments of the invention, given that metal is less prone to degradation and changes over time, as compared to, for example, wood or cardboard. Target 200 may be manufactured in a material/materials that are not prone to deformation and may be stable and durable when built in such materials. While preferred materials for elements have been described, the invention is not limited by these materials.

Embodiments of the invention may also optimize the measurements of RGBD cameras based on stereo to improve the quality of depth information. With reference to FIG. 2D, one of the possible embodiments is for stereo-based depth measurements, where a pattern 250 is added to at least one plane. Pattern 250 may be chosen from a list including: a non-solid colour pattern; a structured pattern; a random pattern; and a fractal pattern. Pattern 250 may cover an entire face of at least one plane, or alternatively a portion thereof. Pattern 250 may reduce a noise in the measurement of RGBD stereo cameras by providing a textured surface which is more easily detected by stereo sensors than a plain, uniform surface. Pattern 250 may improve a stereo camera depth computation. According to some embodiments, planes 201, 202, and 203 of the calibration target may have patterns in different colors, for example, red, green, and blue. In some embodiments, one plane may have a pattern and another plane may be colored. In some embodiments, different planes may have different patterns, for example first vertical plane 202 may have a fractal pattern and second vertical plane 203 may have a structured pattern.

According to some embodiments of the present invention a calibration target, such as calibration target 200, is used in a method for calibrating a sensor attached to a mobile platform such as a robot. Other types of robots, such as robotic arms can be calibrated using the target and methods disclosed herein. However, methods described herein may use targets other than target 200.

Embodiments of the invention include systems for implementing methods disclosed herein. For example, and with reference to FIG. 3 a system may include a mobile platform, mobile unit, or mobile robot 300. Robot 300 may be mobile by wheels or other propulsion system 301, chosen for ease of illustration only; it will be understood that other methods of movement are possible, such as continuous track/caterpillar treads and/or propellors, and that the robot is by no means limited to wheels (nor indeed to only four wheels as shown, but may include any number of wheels such as one, two, or three wheels or any other number). Wheels 301 (or, as discussed, any other type of mobility) may be connected to one or more actuators/motors 302. Control of motors 302 and wheels 301 may be governed by a computing device 304 installed on or within robot 300. Computing device 304 may receive instructions for controlling the movement of robot 300 via a wireless network such as the internet and/or cloud.

Robot 300 may include one or more sensors 303, such as 2D laser sensors, lidar, RGB/RGBD cameras, radar, etc. Sensors 303 may be connected to and/or controlled by computing device 304. Sensors 303 may be calibrated according to methods described herein, for example by sensing, scanning, or otherwise interacting with a target 350, such as calibration target 200 described in FIGS. 2A-2C. As used herein further below, sensors 303 may include both primary sensors and secondary sensors, e.g. sensors with fields of view that overlap at least one other (e.g. primary) sensor.

Computing device 304 may include a controller or computer processor 305 that may be, for example, a central processing unit processor (CPU), a chip or any suitable computing device, an operating system 315, a memory 320, a storage 330, input devices 335 and output devices 340.

Operating system 315 may be or may include code to perform tasks involving coordination, scheduling, arbitration, or managing operation of robot 300, for example, scheduling execution of programs. Memory 320 may be or may include, for example, a Random Access Memory (RAM), a read only memory (ROM), a Flash memory, a volatile or non-volatile memory, or other suitable memory units or storage units. Memory 320 may be or may include a plurality of different memory units.

Executable code 325 may be any application, program, process, task, or script. Executable code 325 may be executed by controller 305 possibly under control of operating system 315. For example, executable code 325 may be one or more applications performing methods as disclosed herein. In some embodiments, more than one computing device 304 or components of device 304 may be used. One or more processor(s) 305 may be configured to carry out embodiments of the present invention by for example executing software or code. Storage 330 may be or may include, for example, a hard disk drive, a floppy disk drive, a Compact Disk (CD) drive, a universal serial bus (USB) device, a cloud storage, or other suitable removable and/or fixed storage unit. Data described herein may be stored in a storage 330 and may be loaded from storage 330 into a memory 320 where it may be processed by controller 305.

Input devices 335 may be or may include a keyboard, a touch screen or pad or any suitable input device or combination of devices. Output devices 340 may include one or more displays, speakers and/or any other suitable output devices or combination of output devices. Any applicable input/output (I/O) devices may be connected to computing device 304, for example, a wired or wireless network interface card (NIC), a modem, a universal serial bus (USB) device or external hard drive may be included in input devices 335 and/or output devices 340.

Embodiments of the invention may include transforms from other reference frames (e.g. a reference frame of a sensor 303) to a reference frame of a fixed point 345 on or within robot 300. Fixed point 345 may be example, a centre of robot 300 (such as a centre in 3D space), or may be another point such as a centre of mass, rotational axis, or moment of inertia. Whilst shown in FIG. 3 as being off-center, fixed point 345 can be any point on or within robot 300.

Embodiments of the invention may include one or more article(s) (e.g. memory 320 or storage 330) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

According to one or more embodiments of the invention there is provided a method of calibrating a plurality of sensors attached to a mobile robot. The mobile robot may be a robot as shown in FIG. 3. The plurality of sensors may include one or more cameras (e.g. RGB camera, depth camera, 2D camera), 2D sensors (e.g. 2D laser 2D sonic sensor), and 360° omnidirectional lidars.

The method may include obtaining, by each sensor of the plurality of sensors a first measurement scan of a calibration target. The calibration target may be a calibration target as described herein.

The method may include determining, for each sensor of the plurality of sensors, based on the first measurement scan, a pose of the calibration target with respect to each sensor. A pose of the calibration target may refer to at least one of a position and/or orientation of the calibration target with respect to a sensor of the plurality of sensors. Each sensor may observe the calibration target as having a different pose with respect to that sensor. A change in pose of the mobile robot may be performed to allow for each sensor to scan the calibration target.

The method may include computing, for each sensor of the plurality of sensors, a first transform from a reference frame of the pose of the calibration target to a reference frame of each sensor. A reference frame for any object, such as a target, robot, or sensor, may be a 6 entry vector in a coordinate system wherein the object is located at the origin e.g. (0, 0, 0, 0, 0, 0) of its reference frame, and other objects are described as located, such as positioned and oriented, with respect to the reference frame of the object. A transform (e.g. a matrix transformation) from a reference frame of the location of the calibration target to a reference frame of a sensor may map the sensor's perception of the environment to reality.

The method may include computing, based on the first transform, a second transform from a reference frame of at least one sensor of the plurality of sensors to a reference frame of a fixed reference point. The fixed reference point may be, for example, a reference point on or within the mobile robot. The fixed reference point may be a point outside the robot, such as a point in the environment in which the mobile robot operates.

According to some embodiments, the method includes changing a pose (e.g. changing at least one of a position and/or orientation) of the mobile robot with respect to the calibration target. The change in pose may be achieved by rotating or translating the mobile robot via its propulsion system, such as wheels 301. A change in pose may be performed to allow sensors which are not pointing in the same direction to obtain measurement data of the same object in the environment, for example to allow each sensor to collect a first set of measurement scans of a calibration target.

The method may include obtaining, by at least one sensor of the plurality of sensors, a second measurement scan of the calibration target. For example, the sensors may each obtain further measurements of the calibration target following the change in pose.

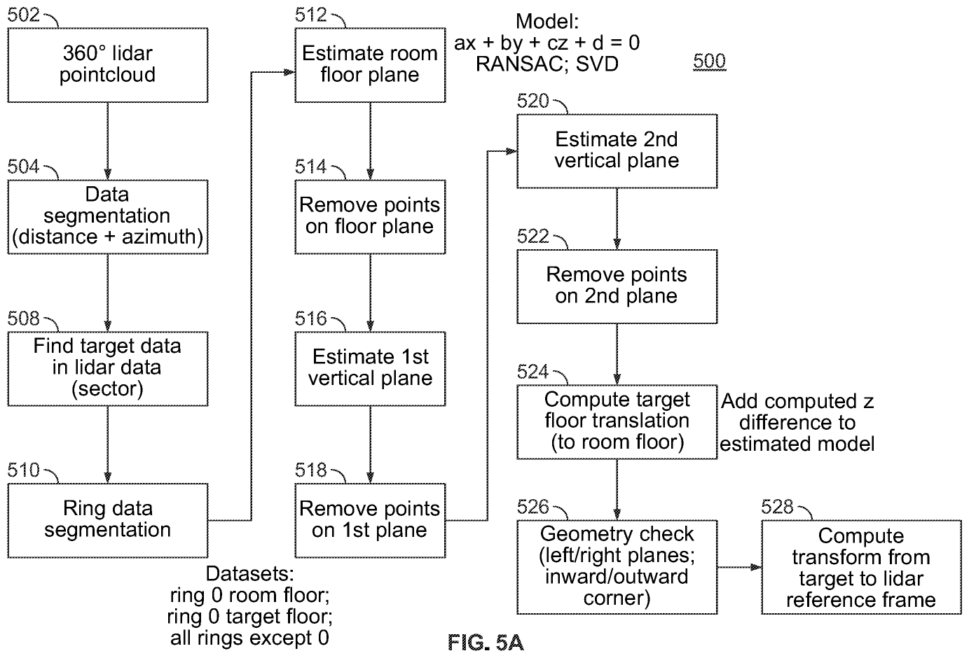

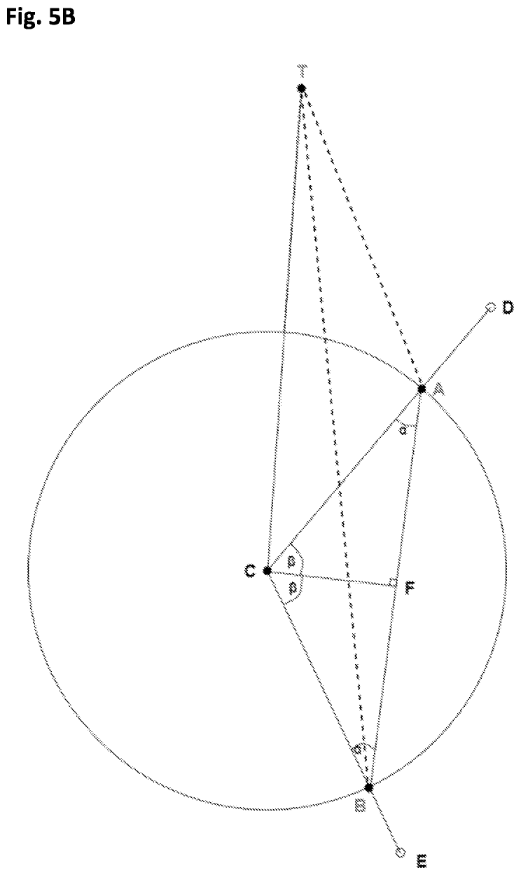

The method may include determining, based on the first and second measurement scans for the at least one sensor, a rotational axis of the mobile robot. The rotational axis may be determined as described herein with respect to FIG. 5B.

According to some embodiments, at least two sensors of the plurality of sensors have an overlapping field of view (FOV). For example the at least two sensors may be mounted on the robot so that they can simultaneously see at least a portion of the same object. The method may include computing the second transform for the at least two sensors of the plurality of sensors with overlapping FOV based on the objects (e.g. common objects common to both FOVs) seen simultaneously by the at least two sensors, e.g. based on the determined poses of the calibration target as viewed simultaneously by each of the at least two sensors with overlapping FOV. For example, based on a first sensor seeing an object (such as the calibration target) at a first object pose relative to the first sensor and a second sensor seeing the same object at a second object pose relative to the second sensor, a transform between the first and second sensors may be computed.

In some embodiments, for example where there is not an overlapping field of view (FOV) between different sensors or sets of sensors, or viewing the same target via different sensors simultaneously, calibration of the pair of sensors/sets of sensors may be achieved via the reference point, provided that the same reference point can be computed or defined for the two sensors/sets of sensors.

In some embodiments, after obtaining a view, image, or scan by a first sensor, the robot may move (e.g. autonomously) so that a second sensor is moved such that its FOV overlaps at least in part with that of the first sensor.

According to some embodiments, at least one sensor of the plurality of sensors is a depth sensor. For example, the depth sensor may be one of a depth camera, a 3D lidar, a 2D laser (e.g. lidar) sensor or a 2D sonic sensor. A depth sensor may obtain multiple distance measurements from the sensor along a line to the first reflecting object whereby these lines are on the same plane. In such cases the calibration target may have features detectable by a depth sensor. The calibration target may include a first plane and a second plane, wherein the first and second planes include structures forming respective third and fourth planes, and wherein a face of the first and second vertical planes each comprise a gap (such as gap 207), wherein each gap includes a structure forming respective fifth and sixth planes.

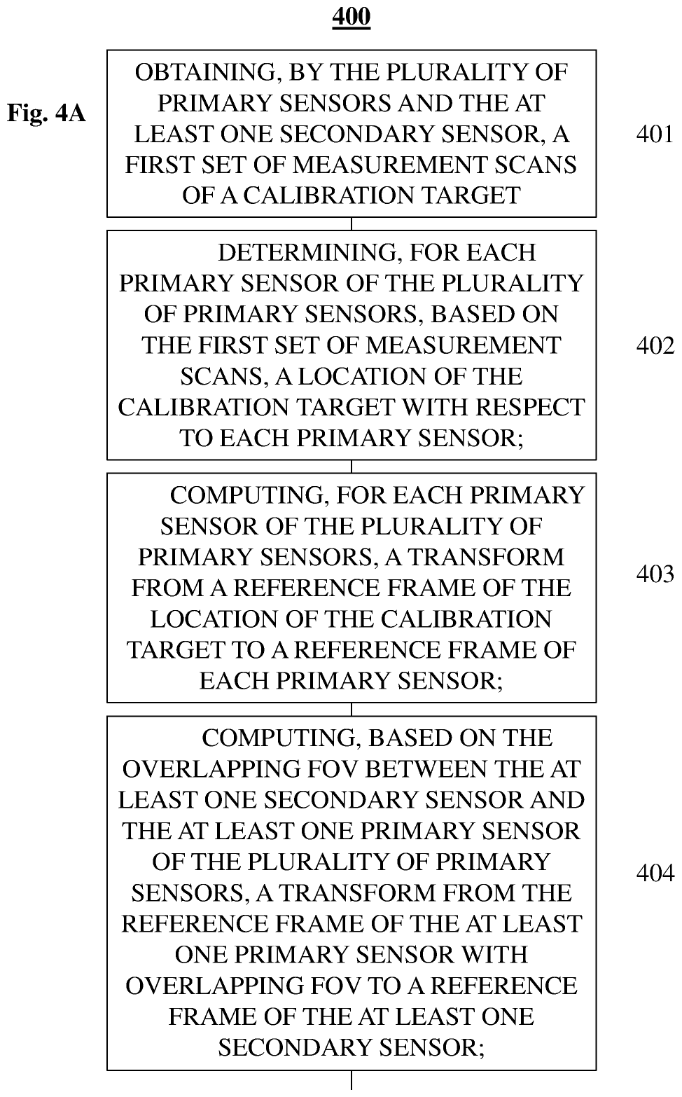

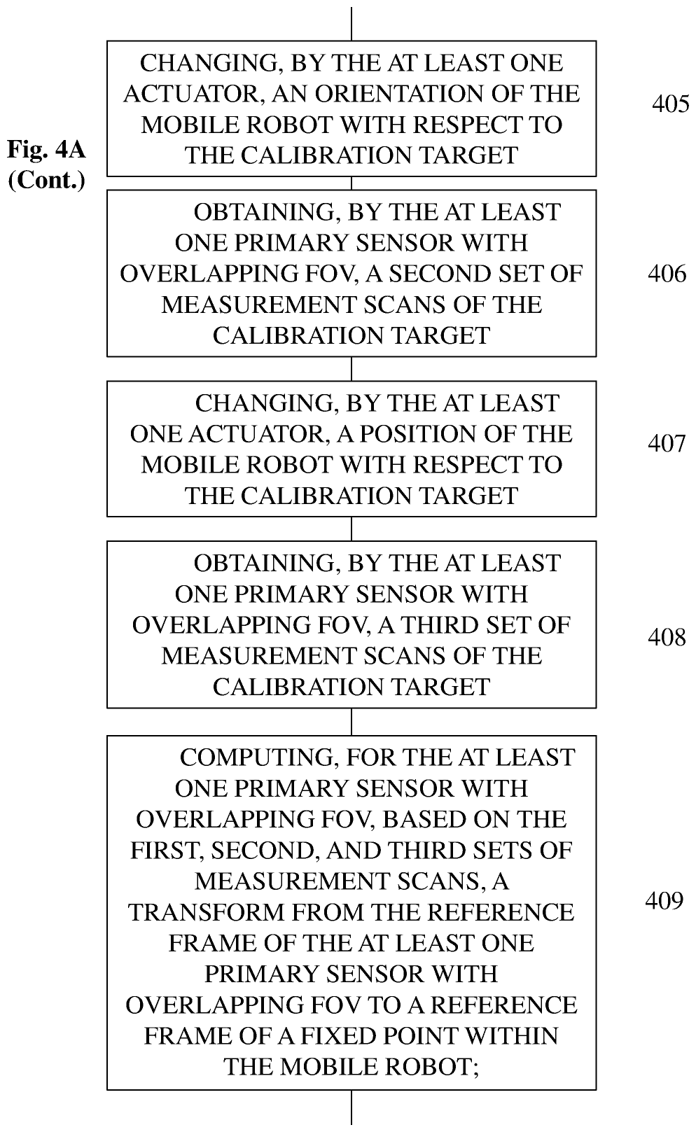

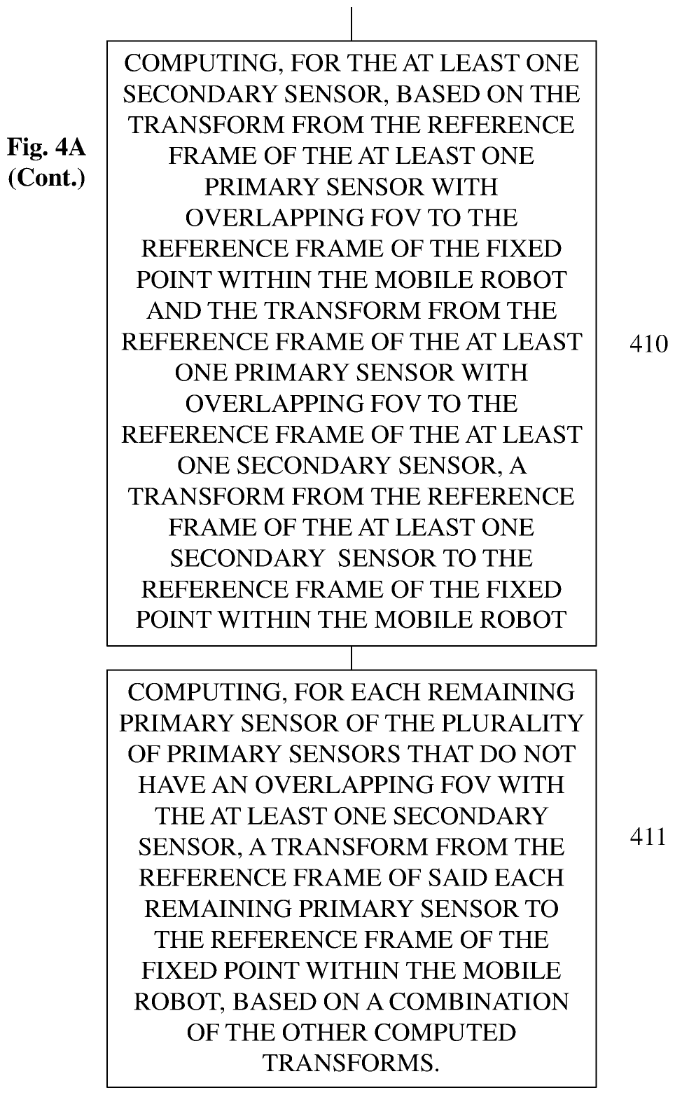

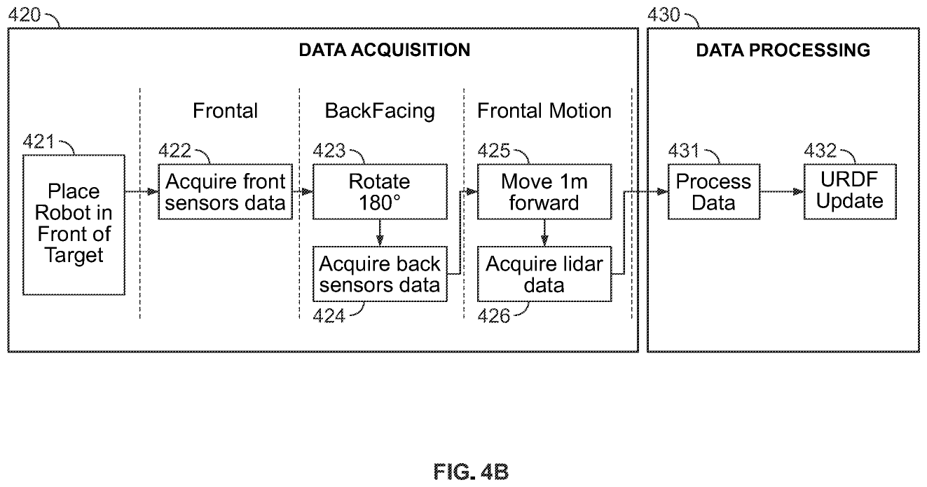

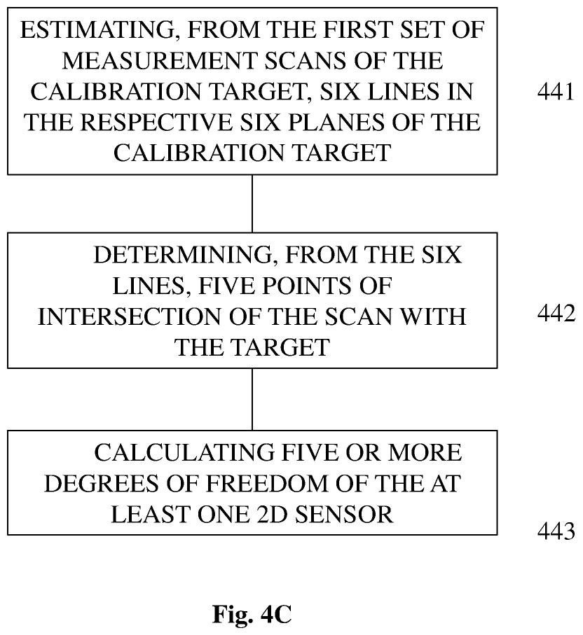

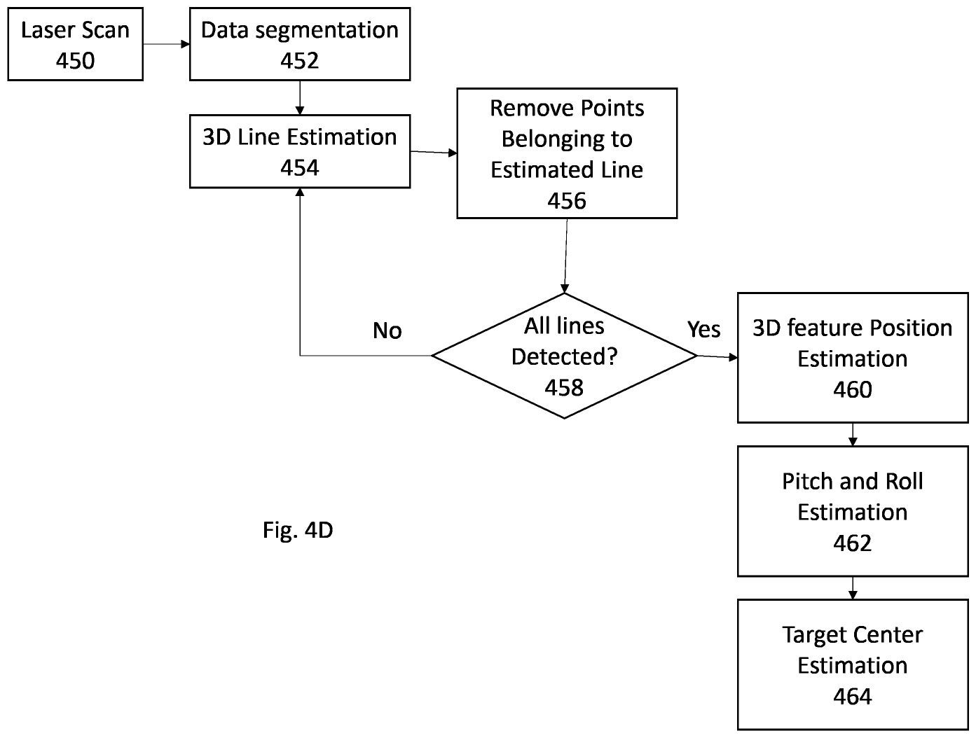

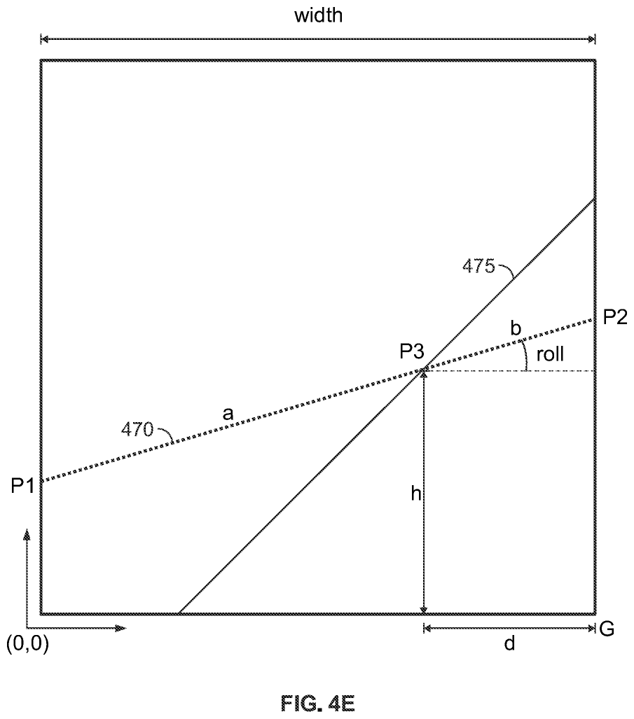

The method may include estimating, from the first measurement scan of the calibration target (e.g. the first measurement scan of the target by the at least one depth sensor), six lines in the respective six planes of the calibration target. The method may include determining, from the six lines, five points of intersection of the planes of the target, and calculating five or more degrees of freedom of the at least one depth sensor. Further detail is provided herein with respect to FIG. 4E.

The method may include, calculating a remaining value of a degree of freedom (e.g. among the six degrees of freedom to be calculated, the one not calculated) for example pitch or an assembly height, of the at least one depth sensor based on a second set of measurement scans of the calibration target obtained following a change of pose of the mobile robot with respect to the calibration target. The change of pose may involve changing a position of the robot so that a distance to the target is changed, for example reducing a distance to the target by instructing the robot to move closer to the target.

According to some embodiments, at least one sensor of the plurality of sensors is a camera. In such cases the calibration target may include a first plane, a second plane, and a ground plane, wherein at least one of the first plane, second plane or ground plane includes at least one of: a color, a pattern, or a combination thereof. The color may include, for example, red, green, blue, white, black or gray, and the pattern may include, for example: a non-solid colour pattern; a structured pattern; a random pattern; or a fractal pattern. Other colours and/or patterns may be used. Each plane may include a different color.

With reference to FIG. 4A, one or more embodiments of the invention relate to a method of calibrating a plurality of primary sensors attached to a mobile robot. FIG. 4A shows an example method 400, according to some embodiments of the invention. The mobile robot may be a robot such as shown in FIG. 3, and may include at least one actuator and at least one secondary sensor with a field of view (FOV) which overlaps a field of view of at least one primary sensor of the plurality of primary sensors. The at least one secondary sensor may be, for example, a 360° omnidirectional lidar, or four cameras mounted respectively to the front, right, rear, and left of the robot so as to afford a nearly 360° FOV. The plurality of primary sensors may include a mixture of different sensors, such as 2D cameras, depth cameras, and 2D lasers. As used herein a “primary sensor” means a sensor other than the secondary sensor, the secondary sensor being such so as to have an overlapping FOV with at least one of the primary sensors. The at least one primary sensor with overlapping FOV with the at least one secondary sensor may be referred to as an “anchor sensor”, and may be the only sensor which takes subsequent measurements for the purpose of calibrating the other primary sensors, such that the total number of measurements in calibrating all sensors can be greatly reduced. An embodiment may be implemented by at least one processor included in the robot, such as processor or controller 305 shown in FIG. 3.

An embodiment may include obtaining (401), by the plurality of primary sensors and the at least one secondary sensor, a first set of measurement scans of a calibration target, for example by taking a sensor reading of the target with all of the sensors.

An embodiment may include determining (402), for each primary sensor of the plurality of primary sensors, based on the first set of measurement scans, a location of the calibration target with respect to each primary sensor. Determining a location of the target may include identifying indicative characteristics in the first set of measurement scans, e.g. data, which correspond to the location and/or orientation of the target: for example, reflections of an incident scan (e.g. laser, radar, camera, etc.) from the target may be received at the sensor and time of flight data for the outgoing-return scan path may be used to determine the location of the target.

An embodiment may include computing (403), for each primary sensor of the plurality of primary sensors, a transform from a reference frame of the location of the calibration target to a reference frame of each primary sensor. A reference frame for any object, such as a target, robot, or sensor, may be a 6 entry vector in a coordinate system wherein the object is located at the origin e.g. (0, 0, 0, 0, 0, 0) of its reference frame, and other objects are described as located, such as positioned and oriented, with respect to the reference frame of the object. A transform (e.g. a matrix transformation) from a reference frame of the location of the calibration target to a reference frame of a sensor may map the sensor's perception of the environment to reality.

An embodiment may include computing (404), based on the overlapping FOV between the at least one secondary sensor and the at least one primary sensor of the plurality of primary sensors, a transform from the reference frame of the at least one primary sensor with overlapping FOV to a reference frame of the at least one secondary sensor. For example, because in one embodiment a secondary sensor has an overlapping FOV with at least one primary sensor the transformation between the two reference frames can be computed based on where the primary sensor observed the target and where the secondary sensor observed the target.

An embodiment may include changing (405), by the at least one actuator, an orientation of the mobile robot with respect to the calibration target. For example, the at least one actuator may impel a propulsion system of the robot (such as wheels) to turn the robot relative to the target, for example to turn the robot 45° with respect to the target. As used herein a change in orientation may refer to a pure rotation about a rotation axis of the robot, e.g. without incurring any change in position of the robot (in particular without a change in position of a fixed point 345 of the robot) relative to the target. A change in orientation may allow for sensors which do not ordinarily have an overlapping field of view (e.g. a front facing and a rear facing camera) to view the same object at different times and thus allow for an artificial overlapping field of view separated in time.

An embodiment may include obtaining (406), by the at least one primary sensor with overlapping FOV, a second set of measurement scans of the calibration target. For example, the second set of measurements may be obtained following the change in orientation.

In some embodiments, the first and second set of measurement scans are used to solve for (e.g. determine) a rotational axis of the robot. For example, the difference between the first set of measurements and the second set of measurements may be used to determine a rotation axis of the robot, as shown, for example, in FIG. 5B.

An embodiment may include changing (407), by the at least one actuator, a position of the mobile robot with respect to the calibration target. For example, the at least one actuator may cause the robot to move forward 1 meter towards the target using its propulsion system. As used herein a change in position may refer to a pure translation of the robot, e.g. without incurring any change in orientation (e.g. no rotation about a fixed point 345 of the robot) relative to the target.

An embodiment may include obtaining (408), by the at least one primary sensor with overlapping FOV, a third set of measurement scans of the calibration target. For example, once the robot has changed its position relative to the target the primary sensor with overlapping FOV may take another (e.g. third) measurement scan of the calibration target.

According to some embodiments, the third set of measurement scans is used to compute the yaw angle of the primary sensor with overlapping FOV relative to a forward direction of motion of the robot. For example, the difference between the first and third sets of measurement scans may be used to determine a yaw of the anchor sensor using geometric principles.

An embodiment may include computing (409), for the at least one primary sensor with overlapping FOV, based on the first, second, and third sets of measurement scans, a transform from the reference frame of the at least one primary sensor with overlapping FOV to a reference frame of a fixed point within the mobile robot. For example, the reference frame of the at least one sensor may be transformed (e.g. with a matrix transformation) with respect to a reference frame of a fixed point on or within the mobile platform (such as fixed point 345) to which the sensor is attached. For example, the fixed point 345 may be the centre of the robot, or another point such as the centre of mass of the robot, rotational axis, or its moment of inertia.

An embodiment may include computing (410), for the at least one secondary sensor, based on the transform from the reference frame of the at least one primary sensor with overlapping FOV to the reference frame of the fixed point within the mobile robot and the transform from the reference frame of the at least one primary sensor with overlapping FOV to the reference frame of the at least one secondary sensor, a transform from the reference frame of the at least one secondary sensor to the reference frame of the fixed point within the mobile robot. For example, having computed (i) the transform from the reference frame of the at least one primary sensor with overlapping FOV to the reference frame of the fixed point within the mobile robot and (ii) the transform from the reference frame of the at least one primary sensor with overlapping FOV to the reference frame of the at least one secondary sensor, the secondary sensor can be related, e.g. have its reference frame transformed, to the reference frame of the fixed point via the anchor sensor.

An embodiment may include computing (411), for each remaining primary sensor of the plurality of primary sensors that do not have an overlapping FOV with the at least one secondary sensor, a transform from the reference frame of said each remaining primary sensor to the reference frame of the fixed point within the mobile robot, based on a combination of the other computed transforms. For example, the other sensors which are not the anchor sensor or the secondary sensor can be related to the fixed point using the transformations already calculated. For example, the transforms could be via the primary sensor with overlapping FOV (anchor sensor) and target or via the secondary sensor and target.

According to some embodiments, based on the computed reference frames and transforms, the robot's movement controller (e.g. controller 305) may more accurately move robot 300 based on input from the various sensors. Embodiments of the invention utilize these reference frames to calibrate the robot and accurately operate the robot within the environment, such that the sensors' view of the environment is accurately mapped to reality.

A calibration target for calibrating a sensor attached to a mobile platform as discussed herein may be a target according to any of the embodiments discussed herein. In some method embodiments, the calibration target may include features detectable by the at least one sensor to be calibrated. For example, if calibrating an RGBD camera, the target may include features detectable by the RGBD camera, such as color, shade, and/or patterns. As another example, when calibrating a 2D sensor the target may include a distinguishing 3D feature, such as a gap 207 or beam.

FIG. 4B shows an example data acquisition process 420 that may be split up into different measurements, for example if a robot is placed in front of a target (421) and includes both front facing and rear facing cameras then a first measurement scan of the target may be obtained for the front facing camera, and a further measurement scan of the target may be obtained using the rear facing camera. Obtaining such a further measurement scan may require a movement or rotation of the mobile platform to which the at least one sensor is attached. For example, the robot may rotate 180° (423) in order to acquire back sensors data, e.g. data from sensors located at the back of the robot (relative to the target). For example, the mobile platform may undergo some frontal motion, such as moving forward 1 meter (425) and may then acquire lidar data (426). These collected data may then be subjected to data processing (430), wherein the data is processed (431) e.g. to detect the target in the data and extract therefrom spatial information. The data processing may be performed within the robot, e.g. by processor/controller 305 shown in FIG. 3, or remotely from the robot. A Unified Robotics Description Format “URDF” for the robot (e.g. a digital file such as an extensible markup language “XML” file describing how the elements of the robot are connected and positioned/oriented with respect to one other) may be updated (432) with the spatial information. For example, the URDF may be stored in memory 320 or storage 330 of the robot shown in FIG. 3. Control of a robot's motion (e.g. via wheels, caterpillar treads, continuous tracks, propellors, motors, etc.) and sensors may be achieved, for example, autonomously or by direct control (e.g. joystick) via actuators or motors 302 and propulsion system 301.

According to some embodiments of the invention, and with reference to FIG. 4C, method 400 shown in FIG. 4A includes additional steps for calibrating at least one two dimensional (2D) sensor attached to a mobile platform. For example, the primary sensor with overlapping FOV (e.g. anchor sensor) described above may be a 2D sensor such as a 2D laser sensor, for example the kind that sends out a laser line and receives reflections which may be interpreted by one or more algorithms along with time of flight data to determine obstacles in a 2D plane. In some embodiments the 2D sensor may be a 2D sonic sensor, that sends out a sound wave and receives reflections which may be interpreted by one or more algorithms along with time of flight data to determine obstacles in a 2D plane.

In embodiments where the primary sensor with overlapping FOV is a 2D sensor, the calibration target may have features detectable by a 2D sensor. For example, the calibration target may include a first plane (e.g. plane 202), a second plane (e.g. plane 203) and a ground plane (e.g. the floor or plane 201). The first and second planes may include structures forming respective third and fourth planes (e.g. planes 205 and 206). The face of the first and second vertical planes may each include a gap (e.g. gap 207), and each gap may include a structure forming respective fifth and sixth planes (e.g. planes 207-2 and 207-3).

In embodiments where the primary sensor with overlapping FOV is a depth sensor the method 400 further includes estimating (441), from the first set of measurement scans of the calibration target, six lines in the respective six planes of the calibration target. Measurement scans for a depth sensor may include, for example, detecting reflections reflected by the target when an incident sensing wave sent out from the sensor intercepts the target. For example, when a 2D laser line scan impacts the target, light may be reflected back to the sensor. The sensor may interpret these reflections alongside time of flight data to estimate a location and distance to an obstacle in the field of view of the sensor, such as calibration target 200; in this way a location of the target can be determined. The method 400 may further include determining (442), from the six lines, five points of intersection of the planes of the target, for example those points of the target which lie in more than one plane. The method may further include calculating (443) five or more degrees of freedom of the at least one depth sensor, for example based on the points of intersection. A degree of freedom of a sensor may be one of the six degrees of freedom, e.g. one of the three translational degrees of freedom or one of the three rotational degrees of freedom. As used herein, pose may be used to refer to at least one of a position and an orientation (e.g. a position and/or an orientation) of a sensor. For example, the pose of a sensor may relate to one or more of the pitch, yaw, roll, height (Z), X displacement and/or Y displacement of the sensor with respect to a reference frame, for example a reference frame of a calibration target.

A calibration target 200 as described and as used in embodiments where the primary sensor with overlapping FOV is a 2D sensor may be constructed so as to provide a difference in the time of flight data, and based on a known relationship between the planes of the target (e.g. as stored in a digital file) the target can be detected in a 2D scan and its location determined. For example, a line scan may intersect points at the edges of the target first, and so reflections may arrive at the sensor before reflections arising closer to the centre of the target (e.g. nearer corner 204). These measurement data can be correlated against the known dimensions of the target to determine at least one of the position/location of the target, the orientation of the target relative to the robot (e.g. how the robot/sensor faces the target, such as straight on with corner 204 centered, or side on with one of the planes of the target dominating more of the sensor field of view) and/or distance to the target relative to the sensor, and derive therefrom lines in the target and subsequently points of intersection with the target. Because of the planar nature of the planes of the target, then, depending on how the target is arranged in the field of view of the 2D sensor, some scan lines of the sensor may lie within a plane of the target, e.g. they may coincide with the target and be coplanar with one of the planes.

With reference to FIG. 4D, obtaining a first measurement scan, e.g. of a calibration target, may include a laser scan 450. In order to make an estimation of lines of the target, embodiments may use data segmentation 452 of the laser scan 450. Data segmentation may identify depth and azimuth in the laser scan. 3D line estimation may be performed (454). The estimation 454 may include random sample consensus (RANSAC) techniques, and the general model of a 3D line L(t)=μ+t·u. Points belonging to an estimated line may be removed (456). Iterative estimations (458) of lines may be made until all lines are detected. Once all lines are detected, embodiments estimate the position of a 3D feature in the laser scan (460), such as a gap 207 or beam included as part of the calibration target. Estimations as to pitch and roll may be made (462) and the target center may be estimated (464).

According to some embodiments, a pitch of the at least one 2D sensor is calculated based on an estimation of the assembly height of the at least one 2D sensor, for example based on a good a priori assumption of the assembly height as may be obtained from manufacturing documentation (e.g. technical drawings, designs and/or blueprints) for the mobile platform.

With reference to FIG. 4E, 5 degrees of freedom can be estimated based on intersections of the 2D laser scan with the calibration target (e.g. 5 intersection points). The 2D sensor may send out a laser line scan 470, shown in FIG. 4E as a dashed line. Laser scan 470 may intersect the borders/edges of a calibration target having a known width (such as target 200) at points P1 and P2. Laser scan 470 may intersect a 3D feature 475 of the target (such as gap(s) 207 with additional structure, e.g. fifth and sixth planes 207-2 and 207-3) at point P3. The height, h, of point P3 may be determined, as well as a distance d from point P3 to the edge of the target. The estimation of the center of the target may be used to estimate (x, y, roll, yaw), plus pitch or height with one measurement of the calibration target, and (x, y, z, roll, pitch, yaw) with two measurements of the calibration target.

According to some embodiments, calibration algorithms for individual sensors (e.g. sensors other than the 2D sensors discussed above), may detect the target origin 204. Different algorithms may be required for different sensors, depending on the data that the sensor provides in terms of density of points and arrangement.

With reference to FIG. 5A, an omni-directional lidar may collect a 360° point cloud of data points (502). The point data may be segmented into distance from the sensor and azimuthal angle (504). Embodiments of the invention may start by selecting a sector in which the calibration target is located (508), in order to discard data from the environment that is not useful for the calibration process. Ring segmentation (510) may be used for estimating the floor of the room by selecting one or more of the rings of the lidar and working only within that ring in order to exclude other points that do not correspond to the floor (e.g. walls, other objects). The segmented data may be used for estimating the three planes of the calibration target (left 202, right 203 and ground 201). For example, the room floor plane may be estimated first (512) using the general equation of a plane ax+by +cz+d=0. Points lying on the estimated floor plane may then be removed (514), and then an estimation of the first vertical plane may be made (516), e.g. left plane 202. Similarly, once estimated, points lying on the first vertical plane may be removed (518), and then an estimation of the second vertical plane may be made (520), e.g. right plane 203. Once estimated, points lying on the second vertical plane may be removed (522).

Some embodiments may use random sample consensus (RANSAC) and single value decomposition (SVD) to estimate individual planes. A final closed solution that forces the solution to perpendicular/orthogonal planes may be determined. Embodiments of the invention may optimize the estimation of the ground plane, given that there the plane representing the physical floor of the environment can also be determined.

In some embodiment, the yaw angle of assembly of the omni-directional lidar may be determined by taking two lidar measurements of the calibration target, one before and one after a translation in the direction of motion of the robot.

Embodiments of the present invention may include a method for estimating the rotation axis of a robot by using two or more lidar measurements, differing in rotation, of the target origin (e.g. 240) and orientation. By comparing the origin of the target (e.g. the known point in the environment) the rotation axis can be computed to determine a reference point for the robot. With reference to FIG. 5B, a calibration geometry is shown. The geometric concept is that for the estimation of the rotation axis of a robot using an omni-directional lidar, using two measurements in different poses by doing a pure rotation movement. In FIG. 5B: point A is the initial location of the lidar; point B is the second location of the lidar, after rotation; point T is the location of a part of a calibration target (e.g. target 200), such as a corner; point C s the location of the rotation axis; angle 2β is the rotation angle between the positions of the two lidar measurement locations A and B; angle α is the angle ∠CAB and is also equal to the angle ∠ABC; point F is the midpoint of the line segment AB; and points D and E are auxiliary points to account for the yaw of the sensor relative to the vector between the rotation axis and the sensor. The described method does not require the sensor at A or B to be aligned with the center C.

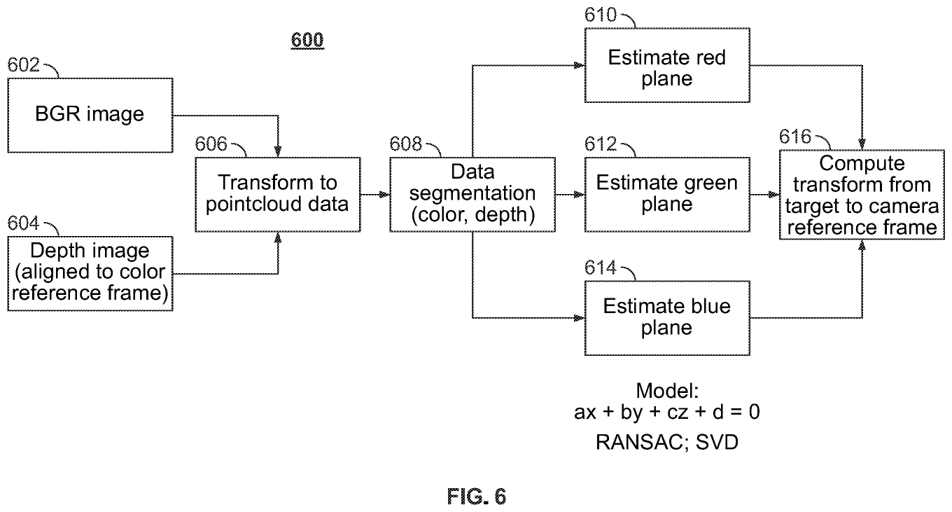

Embodiments of the invention may provide a calibration method for RGBD cameras. With reference to FIG. 6, embodiments of the invention may relate to a method 600 for calibrating at least one RGBD camera attached to a mobile platform such as a robot, using a calibration target, preferably calibration target 200 with planes 201, 202 and 203 colored red, green, and blue, respectively.

Example method 600 may include obtaining (602) an image, such as a BGR image containing blue, green, and red pixels. The image may include a capture view of a calibration target, such as calibration target 200. A depth image may also be obtained (604), such as a depth image aligned to the colour reference frame (e.g. the two images correspond to the same view).

The obtained images may then be transformed (606) to pointcloud data. For example, each point may be expressed as a vector xyz spatial information, such as x, y, z values and color information, such as RGB values. The xyz spatial information may represent a position as measured from an origin, such as corner 204 of calibration target 200. The RGB color information may be expressed as values between 0 and 255, for example red may be expressed as (255,0,0). It will be clear to persons skilled in the art that other color representation formats are available, for example HEX (hexadecimal), HSL (hue, saturation, and lightness), and HSV/HSB (hue, saturation, and value/brightness), and thus those representations discussed herein are not intended to be limiting. Further, other color models such as CMYK (cyan, magenta, yellow, key (black)) will be recognised as falling within the scope of the present invention.

Following transformation of the data, example method 600 may include segmenting (608) the data, for example, segmenting the data based on color and depth. Following the segmentation, method 600 may include estimating the planes in the image, for example estimating the red plane (610), estimating the green plane (612), and estimating the blue plane (614). Segmentation of the three planes of the target may be done based on color in order to select the most reliable points that belong to the calibration target, and to filter the background of the image. Estimating the planes may include using the general equation of a plane ax+by +cz+d=0. RANSAC and SVD techniques may be applied in the same manner as described above for the omni-directional lidar in FIG. 5A. As before, an example algorithm may provide an estimation of the target origin and orientation in the sensor reference frame.

When calibrating visual sensors (such as RGB and RGBD cameras) patterns such as QR codes or other markers, at known positions relative to the calibration target, may be used to calibrate the sensor.

According to some embodiments, the calibration of sensors of a robot includes calibration relative to a reference point. This may be accomplished by using one of the sensors as the main reference of the calibration, and estimating all transforms between this reference sensor and all the other sensors. For example, in some embodiments, the main reference sensor is an omni-directional LIDAR. An omni-directional LIDAR may be a suitable choice for a main reference sensor because of its 360° field of view, because this guarantees that its field of view overlaps with all other sensors.

In preferred embodiments the computation of an additional transform from the main sensor to a reference point in the robot is performed. For example, the reference point in the robot may be chosen by setting a fixed static transform or estimating such a point using the sensors of the robot and measurements of the calibration target or the environment.

Embodiments include calibration of the direction of motion of a robot, which requires movement and data acquisition at least at the start and finishing points of the motion. For example, a robot may perform data acquisition such as scanning a target, and then move closer to the target by a predetermined distance, e.g. 1 meter. Data acquisition may be performed again, and based on a difference in the data it may be determined by what distance the robot actually moved, e.g. whether it did indeed move 1 meter or whether it moved more or less, indicating a miscalibration of the motors/actuators of the robot.

Some embodiments of the invention may include in detecting sensor miscalibration while the mobile platform is operating, either by taking measurements of a calibration target while passing by it or using features in the environment and robot movement. Out of calibration detection is not restricted to the sensors' poses, but can also detect deviations from direction of motion, as well as bad positioning of robot components that happen to be in the FOV of a sensor. The miscalibration detection system gives warning to the operator when the deviation from calibration exceeds acceptable values.

Embodiments include a software tool that when executed, such as in a robot, may allow the generalization of the described embodiments to any suite of sensors, any kind of Autonomous Moving Robot and any arrangement of sensors therein. Such a software tool may allow for extending calibration to new kinds of sensors, the definition of new algorithms for individual sensor processing and the composition of new sensor suites for new robots. A software tool may be embodied as a non-transitory computer readable storage medium containing instructions stored thereon, which when executed by at least one processor in a computing device, cause the processor to execute the software tool.

The software tool may accept any arbitrary number of sensors and stages for calibration. The software tool may allow a developer to extend the tools with more/new algorithms and sensor types. The software tool may allow an integrator (e.g. a high level user) to define strategy for calibration of a new robot such as: choose which sensors to calibrate, define the behavior of the robot (movement) and select the algorithms for each sensor.

The software tool work flow may start from the point of view of a developer (e.g. R&D algorithms) and may extend all the way to the point of view of an integrator (e.g. a person deploying robots in the field). The workflow may, for example, include:
1. Develop individual sensor processing nodes for new sensors/setups/functionalities that are not supported yet;
2. Develop calibration finalization software for each new robot type (set of sensors) that is not supported yet;
3. Define a reference frame for the calibration (baselink, one of the sensors . . . );
4. Create calibration workflow;
4.1 Add drivers for the robot;
4.2 Select individual sensor processing functions;
4.3 Add a calibration finalization function;
4.4 Add behavior of the robot (motion);
4.5 Add actions depending on the (valid/failed) result;
5. Assemble calibration target;
6. Prepare setup for calibration;
6.1 Free space around target (e.g. no obstacles, floor cleared);
6.2 Place the robot in front of target (in starting position/orientation); and
7. Execute calibration work flow.

Embodiments of the invention may improve the technologies of robotics, autonomous robotics, and unmanned mobile units.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method of calibrating a plurality of sensors attached to a mobile robot, the method comprising:
obtaining, by each sensor of the plurality of sensors, a first measurement scan of a calibration target;
determining, for each sensor of the plurality of sensors, based on the first measurement scan, a pose of the calibration target with respect to each sensor;
computing, for each sensor of the plurality of sensors, a first transform from a reference frame of the pose of the calibration target to a reference frame of each sensor; and
computing, based on the first transform, a second transform from a reference frame of at least one sensor of the plurality of sensors to a reference frame of a fixed reference point.

2. The method of claim 1, comprising:
changing a pose of the mobile robot with respect to the calibration target;
obtaining, by at least one sensor of the plurality of sensors, a second measurement scan of the calibration target; and
determining, based on the first and second measurement scans for the at least one sensor, a rotational axis of the mobile robot.

3. The method of claim 1, wherein at least two sensors of the plurality of sensors have an overlapping field of view (FOV) and wherein computing the second transform for said at least two sensors of the plurality of sensors with overlapping FOV is based on the determined poses of the calibration target as viewed simultaneously by each of said at least two sensors with said overlapping FOV.

4. The method of claim 1, wherein at least one sensor of the plurality of sensors is a depth sensor,
wherein the calibration target comprises a first plane and a second plane,
wherein the first and second planes comprise structures forming respective third and fourth planes, and
wherein a face of the first and second planes each comprise a gap, wherein each gap comprises a structure forming respective fifth and sixth planes,
and wherein the method further comprises:
estimating, from the first measurement scan of the calibration target, six lines in the respective six planes of the calibration target;
determining, from the six lines, five points of intersection of the planes of the target; and
calculating five or more degrees of freedom of the at least one depth sensor.

5. The method of claim 4, comprising calculating a remaining degree of freedom of the at least one depth sensor based on a second measurement scan of the calibration target obtained following a change of pose of the mobile robot with respect to the calibration target.

6. The method of claim 4, wherein the depth sensor is one of: a depth camera, a 3D lidar, a 2D laser sensor or a 2D sonic sensor.

7. The method of claim 1, wherein at least one sensor of the plurality of sensors is a camera,
wherein the calibration target comprises a first plane, a second plane, and a ground plane,
and wherein at least one of the first plane, second plane or ground plane comprises at least one of: a color, a pattern, or a combination thereof.

8. The method of claim 7, wherein the pattern comprises: a non-solid colour pattern; a structured pattern; a random pattern; or a fractal pattern.

9. The method of claim 1, wherein the fixed reference point is a point on or inside the mobile robot.

10. The method of claim 1, wherein the fixed reference point is a point in an environment in which the mobile robot operates.

11. A system for calibrating a plurality of sensors attached to a mobile robot, the system comprising a memory, and at least one processor configured to receive instructions which cause the at least one processor to:
obtain, by each sensor of the plurality of sensors, a first measurement scan of a calibration target;
determine, for each sensor of the plurality of sensors, based on the first measurement scan, a pose of the calibration target with respect to each sensor;
compute, for each sensor of the plurality of sensors, a first transform from a reference frame of the pose of the calibration target to a reference frame of each sensor; and
compute, based on the first transform, a second transform from a reference frame of at least one sensor of the plurality of sensors to a reference frame of a fixed reference point.

12. The system of claim 11, wherein the processor is further configured to:
change a pose of the mobile robot with respect to the calibration target;
obtain, by at least one sensor of the plurality of sensors, a second measurement scan of the calibration target; and
determine, based on the first and second measurement scans for the at least one sensor, a rotational axis of the mobile robot.

13. The system of claim 11, wherein at least two sensors of the plurality of sensors have an overlapping field of view (FOV) and wherein the at least one processor is configured to compute the second transform for said at least two sensors of the plurality of sensors with overlapping FOV based on the determined poses of the calibration target as viewed simultaneously by each of said at least two sensors with said overlapping FOV.

14. The system of claim 11, wherein at least one sensor of the plurality of sensors is a depth sensor,
wherein the calibration target comprises a first plane and a second plane,
wherein the first and second planes comprise structures forming respective third and fourth planes, and
wherein a face of the first and second planes each comprise a gap, wherein each gap comprises a structure forming respective fifth and sixth planes,
and wherein the at least one processor is configured to:
estimate, from the first measurement scan of the calibration target by the at least one depth sensor, six lines in the respective six planes of the calibration target;
determine, from the six lines, five points of intersection of the planes of the target; and
calculate five or more degrees of freedom of the at least one depth sensor.

15. The system of claim 14, wherein the at least one processor is configured to calculate a remaining degree of freedom of the at least one depth sensor based on a second set of measurement scans of the calibration target obtained following a change of pose of the mobile robot with respect to the calibration target.

16. The system of claim 14, wherein the depth sensor is one of: a depth camera, a 3D lidar, a 2D laser sensor or a 2D sonic sensor.

17. The system of claim 11, wherein at least one sensor of the plurality of sensors is a camera,
wherein the calibration target comprises a first plane, a second plane, and a ground plane,
and wherein at least one of the first plane, second plane or ground plane comprises at least one of: a color, a pattern, or a combination thereof.

18. The system of claim 11, wherein the fixed reference point is a point on or inside the mobile robot.

19. The system of claim 11, wherein the fixed reference point is a point in an environment in which the mobile robot operates.

20. A non-transitory computer readable storage medium containing instructions which, when executed by at least one processor of a robot comprising a plurality of sensors cause the at least one processor to:
obtain, by each sensor of the plurality of sensors, a first measurement scan of a calibration target;
determine, for each sensor of the plurality of sensors, based on the first measurement scan, a pose of the calibration target with respect to each sensor;
compute, for each sensor of the plurality of sensors, a first transform from a reference frame of the pose of the calibration target to a reference frame of each sensor; and
compute, based on the first transform, a second transform from a reference frame of at least one sensor of the plurality of sensors to a reference frame of a fixed reference point.
